(19) United States
(12) Patent Application Publication
(10) Pub. No.: US 2007/0114267 A1
(43) Pub. Date: May 24, 2007

(54) Method for making a backlight module frame

(75) Inventor: Tung-Ming Hsu, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/453,961

(22) Filed: Jun. 15, 2006

(30) Foreign Application Priority Data
Nov. 23, 2005 (CN) 200510101761.7

(51) Int. Cl. B23K 31/02

(52) U.S. Cl. 228/155

(57) ABSTRACT

A method for making a backlight module frame includes: providing at least two starting components; welding the starting components at the edges to form a semi-manufactured frame; pressing the semi-manufactured frame to form a backlight module frame. The backlight module frame can be manufactured easily by said method and has smooth surfaces. Furthermore, the method can low the cost of material.

### FIELD OF THE INVENTION

The present invention relates to a method for making a backlight module frame, and is particularly useful in the production of backlight module for a liquid crystal display device.

### BACKGROUND

A typical liquid crystal display device comprises a liquid crystal display panel, and a backlight module mounted under the liquid crystal display panel for supplying light thereto. The backlight module mainly comprises a light source, a light guide plate, and a frame. The light guide plate is made of a transparent acrylic plastic, and is used for guiding light received from the light source to uniformly illuminate the liquid crystal display panel. The frame is usually made of metal, and used for providing a high mechanical strength to protect the light guide plate and the light source, further providing an electromagnetic shield capability.

A typical method of making a backlight module frame includes the steps of: providing a metal sheet whose said outer contour corresponds to the subsequent frame; pressing the metal sheet to form a semi-manufactured frame, wherein the interior portion of the metal sheet is punched out from the metal sheet; pressing the semi-manufactured frame to form a backlight module frame. However, this method is disadvantageous because the interior portion of the metal sheet is wasted. If the inner area, due to its small size, cannot be used for smaller frames, this material will be wasted, increasing the cost of manufacture.

Another typical method of making a backlight module frame includes the steps of: providing a number of individual starting components that are cut to proper length; respectively pressing the starting components to form a unit corresponding to the subsequent unit form of the frame; assembling units to form a semi-manufactured frame corresponding to the subsequent form of the frame; and welding the semi-manufactured frame to manufacture a backlight module frame. Although, this method of making a backlight module frame may low the cost of manufacture, the welding procedures for producing frames are disadvantageous in that the bead of the weld seam that forms in both electric butt-welding and pressure welding damages the smoothness of the weld surfaces of the backlight module frame. This necessitates grinding or planning the protruding weld seams that, in turn, is quite time-consuming and limits automation in frame production.

What is needed, therefore, is a method for making a backlight module frame that overcomes the above mentioned disadvantages.

### SUMMARY

The present invention provides a method for making a backlight module frame. A preferred embodiment of the method includes the steps of: providing at least two starting components; welding the starting components at the edges to form a semi-manufactured frame; pressing the semi-manufactured frame to form a backlight module frame.

Other advantages and novel features will become more apparent from the following detailed description of preferred embodiments when taken in conjunction with the accompanying drawings.

### BRIEF DESCRIPTION OF THE DRAWINGS

Many aspects of the method for making a backlight module frame can be better understood with reference to the following drawings. The components in the drawings are not necessarily to scale, the emphasis instead being placed upon clearly illustrating the principles of the present method. Moreover, in the drawings, like reference numerals designate corresponding parts throughout the several views.

FIG. 1 is a flow chart of a method for making a backlight module frame according to a preferred embodiment;

FIG. 2 is a schematic, top plan view of two starting components provided for making a backlight module frame according to the first preferred embodiment;

FIG. 3 is a schematic, top plan view of a semi-manufactured frame produced by welding the two starting components of FIG. 2;

FIG. 4 is a schematic, perspective view of a backlight module frame produced by pressing the semi-manufactured article of FIG. 3;

FIG. 5 is a schematic, top plan view of four starting components provided for making a backlight module frame according to the second preferred embodiment;

FIG. 6 is a schematic, top plan view of t a semi-manufactured frame produced by welding the four starting components of FIG. 5; and

FIG. 7 is a schematic, perspective view of a backlight module frame produced by pressing the semi-manufactured article of FIG. 6.

### DETAILED DESCRIPTION OF THE PREFERRED EMBODIMENTS

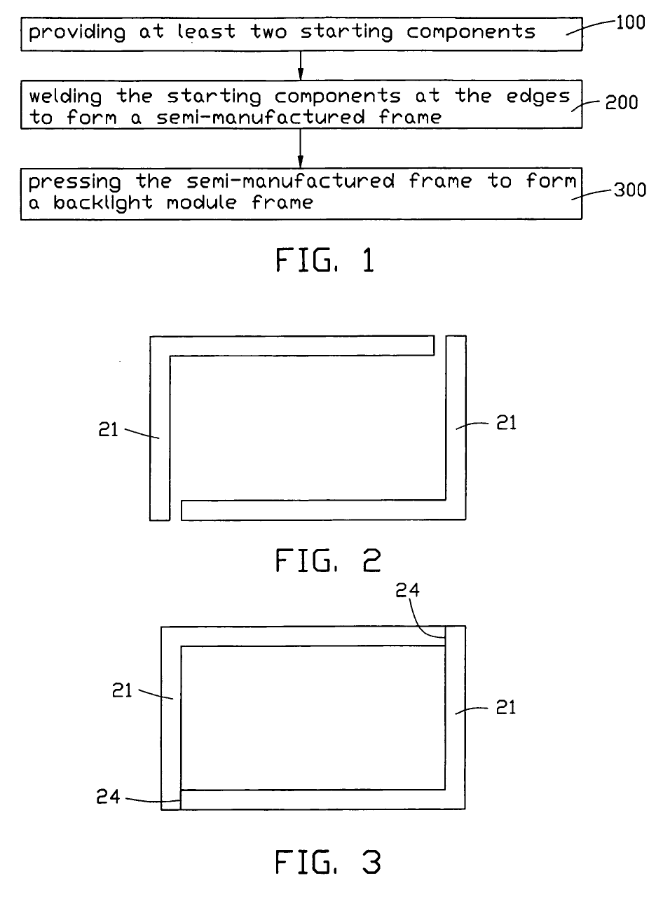

FIG. 1 is a flow chart of a method for making a frame of an electronic module like a backlight module. The method includes the steps of, in the order of:
step 100: providing at least two starting components or pieces of raw material;
step 200: welding/joining the starting components/pieces of raw material at the edges to form a semi-manufactured frame with a hollow central area for further treatment;
step 300: pressing or stamping the semi-manufactured frame to form a backlight module frame.

In step 100, the starting components may be produced with single pieces punched from a metal sheet. A shape of each starting component can be selected from a group consisting of rod-shaped, L-shaped, similar U-shaped and other suitable shapes that may be assembled to form a shape of the backlight module frame. Each starting component has a smooth surface. Lengths and/or widths of the starting components are configured to be larger than that of the subsequent backlight module frame, because the subsequent pressing step may consume a little of the lengths and/or widths of the starting components.

In step 200, the starting components are arranged to be in contact with each other at the edges thereof, and are welded together by a welding apparatus. The welding apparatus is preferably selected from a group comprising a C0₂ high performance laser and an Nd-YAG laser. The wielding apparatus may have a control interface that allows external programming and setting the laser power cycles, pulse programs, pulse frequency, and laser power. In an analog laser power control that is controlled directly by a computerized numerical control, one has the ability to control the laser power's path-dependency, rate-dependency, time-dependency or laser power levels. When utilizing the laser beam to weld the starting components together, the heat areas adjacent to the edges of the starting components are small, thus, resulting individual weld seams produced by the laser beam are significantly small. Furthermore, the size of the semi-manufactured frame may not be affected a lot due to the laser welding process. In addition, the semi-manufactured frame will have a smooth surface without any protruding weld seams produced thereon due to advantages utilizing the laser welding process.

In step 300, the semi-manufactured frame may be pressed or stamped by a pressing/stamping equipment to form a backlight module frame according to a backlight design.

Reference will now be made to the drawings to describe a first preferred embodiment of the present method of making a backlight module frame in detail.

Referring to FIG. 2, two L-shaped starting components 21 are provided. The two L-shaped starting components 21 have a same shape. Each L-shaped starting component 21 has a long rectangular band (not labeled) and a short rectangular band (not labeled).

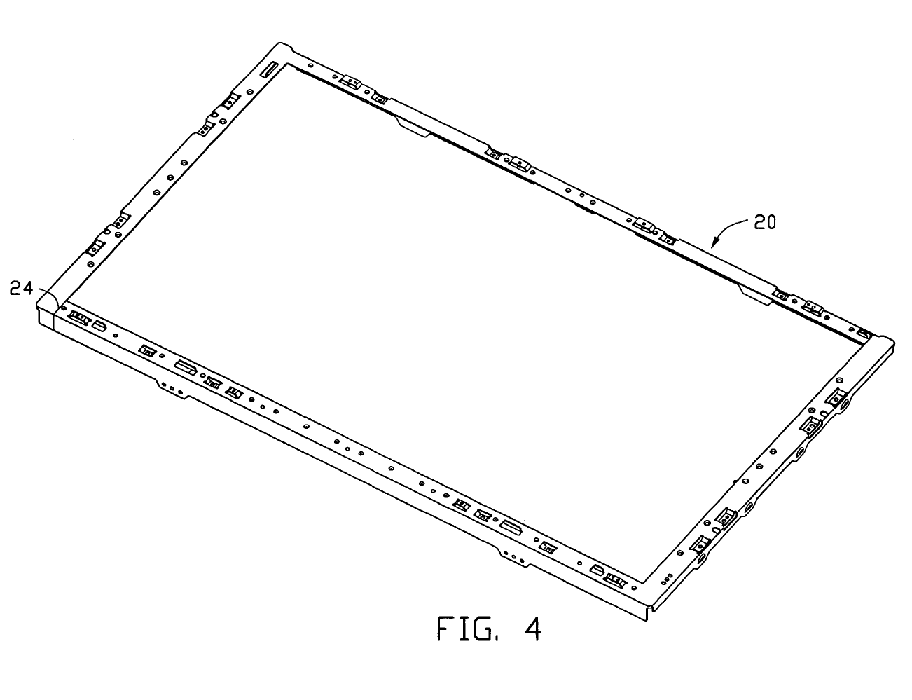

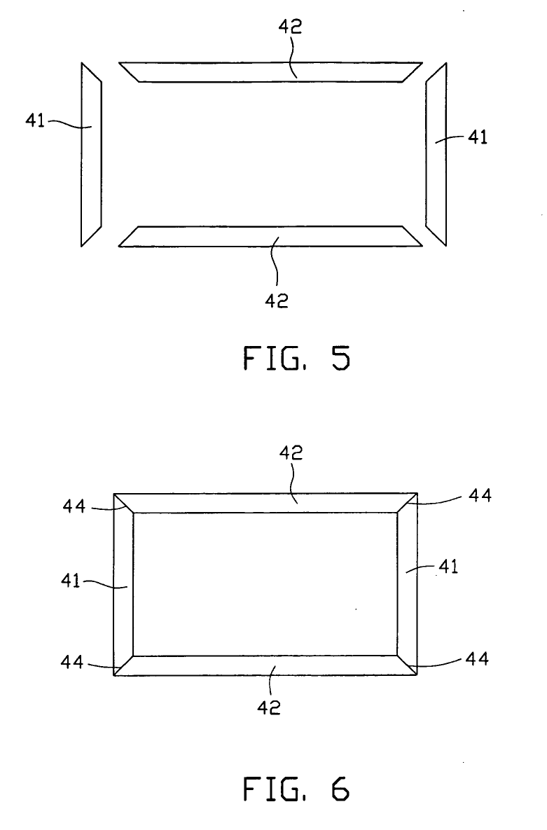

Referring to FIG. 3, the two L-shaped starting components 21 are assembled such that a long band of one starting component 21 interconnects a short band of the other starting component 21, thereby a close frame shape is formed and two connection portion 24 are respectively defined between the two L-shaped starting components 21. A semi-manufactured frame is formed by utilizing a laser beam to weld the connection portions 24 together. The semi-manufactured frame has smooth surfaces and enough mechanical strength to bear with a subsequent pressing process. Furthermore, before welding the starting components 21, the ends of the long and short bands should be polished thoroughly. This polishing process allows the two L-shaped starting components 21 connecting tightly and increase the laser welding quality.

Referring to FIG. 4, the semi-manufactured frame may be pressed by a press equipment to form a backlight module frame 20 according to a backlight design. It is to be understood that this pressing process may include more than one stamping processes if necessary. It is noted that areas around the connection portions 24 of the backlight module frame 20 are smoother than that of semi-manufactured frame before the pressing process.

Reference will now be made to the drawings to describe a second preferred embodiments of the present method of making a backlight module frame in detail.

Referring to FIG. 5, two short starting components 41 and two long starting components 42 are provided. A shape of each starting component 41 or 42 is an elongated rod. Two ends of each starting component 41 or 42 respectively define a slanting surface thereof, and each slanting surface has an acute angle. The sum of the acute angle of one end of the short starting components 41 and an acute angle of one end of the long starting components 42 is 90 degrees, thus, when the short starting components 41 is arranged to connect with the long starting components 42 at the slanting surface of the ends thereof, a rectangular corner may be defined by the short starting component 41 and the long starting component 42.

Referring to FIG. 6, the two short starting components 41 and the two long starting components 42 are assembled to form a closed frame shape, wherein two short starting components 41 and the two long starting components 42 are disposed opposite to each other. The two ends of each short starting component 41 are connected with two long starting components 42, thus, four connection portions 44 are defined between the short starting components 41 and the long starting components 42. A semi-manufactured frame is formed by utilizing a laser beam to weld the four connection portions 44 together. The semi-manufactured frame has smooth surfaces and enough mechanical strength to bear a subsequent pressing process. Furthermore, before welding the starting components 41 and 42, the ends of the starting components 41 and 42 should be polished thoroughly. Polishing allows the starting components 41 and 42 to connect tightly and increase the laser welding result. In an alternative embodiment, two ends of each starting component may also be configured to a rectangular surface.

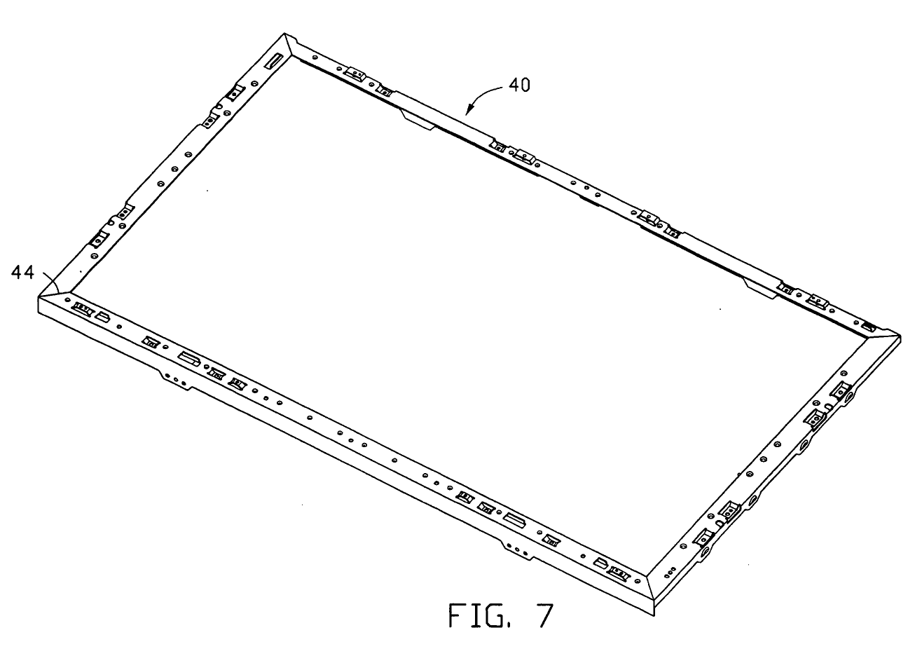

Referring to FIG. 7, the semi-manufactured frame may be pressed by a press equipment to form a backlight module frame 40 according to a scheduled design.

In order to decrease the time consumption of the welding process of said method, the backlight module frame is to have less weld seams. It is to be understood that a shape of the starting components can be configured to an U-shaped liked, thereby two of this U-shaped starting components may be provided to form a backlight module frame using the present method, and the backlight module frame only having two weld seams. It is noted that a combination of starting components having different shapes may also be provided to manufacture a backlight module frame.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A method for making a backlight module frame, the method comprising the steps of:
providing at least two starting components;
welding the starting components at the edges to form a semi-manufactured frame; and
pressing the semi-manufactured frame into a backlight module frame.

2. The method as recited in claim 1, wherein a shape of the starting components can be selected from a group comprising of rod-shaped, L-shaped and U-shaped liked.

3. The method as recited in claim 1, wherein a shape of the starting component is an elongate rod, and two ends of the starting component define a slanting surface respectively.

4. The method as recited in claim 1, wherein the starting components are made of metals.

5. The method as recited in claim 1, wherein the welding process is used with one of a C0₂ gas laser and/or an Nd: YAG solid-state laser.

6. The method as recited in claim 1, wherein ends of the starting components may be polished before the welding process.

7. A method for making a frame having a hollow central area, the method comprising the steps of:
preparing at least two pieces of raw material for making a frame which is preset to have a hollow central area therein;
placing each of said at least two pieces of raw material along at least one exclusively preset side of said frame to be made beside said hollow central area thereof;
mechanically joining said at least two pieces of raw material to each other according to a preset shape of said frame to be made defining said at least one exclusively preset side; and
stamping said each of said at least two pieces of raw material to form said frame to be made.

8. A method for making a frame used to surround an electronic module, the method comprising the steps of:
preparing at least two independently integral pieces of raw material for making a frame of an electronic module;
placing each of said at least two pieces of raw material at an exclusively preset surrounding position of said frame by means of substantially avoiding a preset occupying position of said electronic module;
mechanically joining said at least two pieces of raw material to each other according to said preset surrounding position; and
further treating said each of said at least two pieces of raw material to form said frame of said electronic module.
